(19) United States
(12) Patent Application Publication
(10) Pub. No.: US 2002/0140966 A1
(43) Pub. Date: Oct. 3, 2002

(54) Systems and methods for managing software updates for printing systems

(76) Inventors: William K. Meade II, Eagle, ID (US); Robert E. Haines, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/825,207

(22) Filed: Apr. 2, 2001

(51) Int. Cl. G06K 15/02; G06F 3/12; G06F 13/00; G06F 9/00

(52) U.S. Cl. 358/1.15; 717/168; 717/171

(57) ABSTRACT

Systems and method for managing software updates for printing devices utilize component memory to provide ways to notify printing device users that a software update for the printing device is available. Upon authorization by a user, the user is also provided with means to obtain the software update, either by downloading the software update to the printing device or a host computer or by manually contacting a vendor. The process may also be accomplished automatically. The component memory may also store a pointer to an Internet web site from which the software update may be downloaded. The component memory is radio frequency identifier memory and, therefore, different software update information intended for different printing device users may be stored immediately prior to shipping replacement components.

### TECHNICAL FIELD

The systems and methods described herein relate to toner cartridges that include integrated memory. More particularly, systems and methods are described for using printing device component memory to manage printing system software updates.

### BACKGROUND

Software for printing systems (one or more printing devices and a host computer system) is constantly evolving as companies that develop the software strive to engineer new and useful programs to expand and supplement the original software that is shipped with printing devices. Printing device manufacturers are anxious to have printing device users upgrade original software on legacy printing devices and/or computers to which the printing devices are connected. Some upgrades that are made available provide a financial reward for manufacturers, while others are offered simply to increase the productivity of the printing system and thus enhance the user's experience with the printing device.

Currently, a user has several options to update software related to a printing system. One way is to procure the new software on some sort of computer-readable medium, such as a floppy disk or a CD-ROM, and load the software on a computer and/or download the software to the printing device. Another way is for the user to access a remote access site, such as an Internet website, and download the new software, which can then be installed on the computer or the printing device. A user may also request that the printing device manufacturer automatically notify the user when updated software is available, at which time the user can manually request the software update or whereby the new software is automatically sent to the user.

Sometime, manufacturers find that it is difficult to encourage printing device users to upgrade software related to their printing device. In addition to individual users, corporate environments that may include hundreds of printers and/or computers may be even more difficult to persuade, in part, because of the time that is presently required to update each printing device and/or each computer connected to the printing device.

Manufacturers must also take care not to overburden users with updates or update information. User may be frustrated if unnecessary updates automatically occur, or if they are prompted to update software when their software is current. Users must be allowed to control what is updated and when it is updated.

### SUMMARY

The systems and methods for managing printing system updates described herein provide an efficient way for a printing device manufacturer or software vendor that distributes printing device software to notify users that an update for the user's printing system is available. Means are also described for providing an efficient and simplified way for a user to access and/or retrieve the software update. Updates are only initiated upon authorization from a user.

Replaceable cartridges are manufactured that include integrated memory (typically in the form of a radio frequency identification (RFID) tag) that stores various parameters associated with the printing device that uses the cartridge. This memory is utilized in the described implementations to store information to facilitate notifying a user of the availability of updated software and providing the user with a relatively easy way to obtain the updated software.

In one implementation, the updated software to be provided to the user is simply stored in the cartridge memory. Installation of the cartridge triggers a user message that informs the user that the updated software is available and can be transferred to the printing device and/or the user's computer upon authorization from the user. Alternately, the cartridge memory may store a pointer to a location where the update is stored, such as an Internet web site. Upon receiving authorization from the user, the system can then access the update and download it to update the system software.

In another implementation, update information is stored in the cartridge memory that the printing system can utilize to determine if an update is required by the system. For example, the cartridge memory may include a revision number that the printing system can compare to a revision number of the software currently in use. If the revision number stored in the cartridge memory is later than the revision number of the software currently used in the system, the system will become aware that an update is available and will query an appropriate person to determine if the system software should be updated.

For added flexibility, a pointer may also be stored in the cartridge memory. Then, if the system software requires updating and the update is authorized, the printing device or a host computer can use the pointer to access the updated software and download the update to the system. One example of a pointer that can be used in this way is a pointer to an Internet site contains the update.

In yet another implementation, a pointer to an Internet site is included in the cartridge memory and the printer or the connected computer utilizes the pointer to determine whether an update is required and available. If an update is required and is available at the referenced website, then the update is automatically downloaded to the printing device or the host computer of the printing system. As will be discussed below, automatic downloading requires pre-authorization from the user to install the update.

Different approaches to storing update information in the cartridge memory are also described. According to one implementation, the update information is stored in the cartridge memory by the cartridge manufacturer after the cartridge has been manufactured. This programming can be aimed at the general product-using public or it can be specifically tailored to a certain group of product users. For example, if the updated software is a printer driver, the same information will be stored in each cartridge at the time of manufacture or sometime later prior to shipping. Use of radio frequency identifier memory on the cartridges allows the information to be stored after several cartridges have been packaged for delivery, such as on a shipping pallet.

If, however, there is a software update that is specifically targeted, for example, to commercial users as opposed to personal users, it may be desirable to store the software update information only in cartridges that are shipped to commercial users. In this case, cartridges can be programmed on the shipping dock according to the destination of the cartridges.

Additionally, different cartridge vendors may wish to add unique vendor information to the cartridge memory. In the case where an RFID memory tag is utilized with the toner cartridge, physical contact between the RFID memory tag and a device that stores data in the RFID memory tag is not required. Therefore, a vendor can write data to the RFID memory tag after the cartridge has been packaged. This provides a great measure of convenience for a vendor, as the vendor can write to several toner cartridges simultaneously, such as to an entire pallet of toner cartridges shipped from a manufacturer.

### BRIEF DESCRIPTION OF THE DRAWINGS

A more complete understanding of exemplary methods and arrangements of the present session-state manager may be had by reference to the following detailed description when taken in conjunction with the accompanying drawings wherein:

FIG. 1 is a representation of a system having a printer and a computer, the computer communicating with a vendor via the Internet.

FIG. 2 is an illustration of a laser printer toner cartridge having integrated memory.

FIG. 3 is a block diagram of a system for managing software updates for printing devices.

FIG. 4 is a flow diagram depicting a method for managing software updates in printing systems.

FIG. 5 is a flow diagram depicting a method for automatically managing software updates in a printing system.

### DETAILED DESCRIPTION

The invention is illustrated in the drawings as being implemented in a suitable computing environment. Although not required, the invention will be described in the general context of computer-executable instructions, such as program modules, to be executed by a computing device, such as a personal computer, a hand-held computer or portable electronic device. Generally, program modules include routines, programs, objects, components, data structures, etc., that perform particular tasks or implement particular abstract data types. Moreover, those skilled in the art will appreciate that the invention may be practiced with other computer system configurations, including multi-processor systems, microprocessor-based or programmable consumer electronics, Internet appliances that have consumable or replaceable memory, wireless phones with replaceable memory, digital music players with replaceable memory, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

General reference is made herein to one or more printing device. As used herein, “printing device” means any electronic device having data communications and data storage capabilities, and functions to render printed characters on a print medium. A printing device may be a printer, fax machine, copier, plotter, and the like. The term “printer” includes, but is not limited to, laser printers, ink jet printers, dot matrix printers, dry medium printers, copiers, facsimile machines and plotters. Although specific examples may refer to one or more of these printers, such examples are not meant to limit the scope of the claims or the description, but are meant to provide a specific understanding of the described implementations.

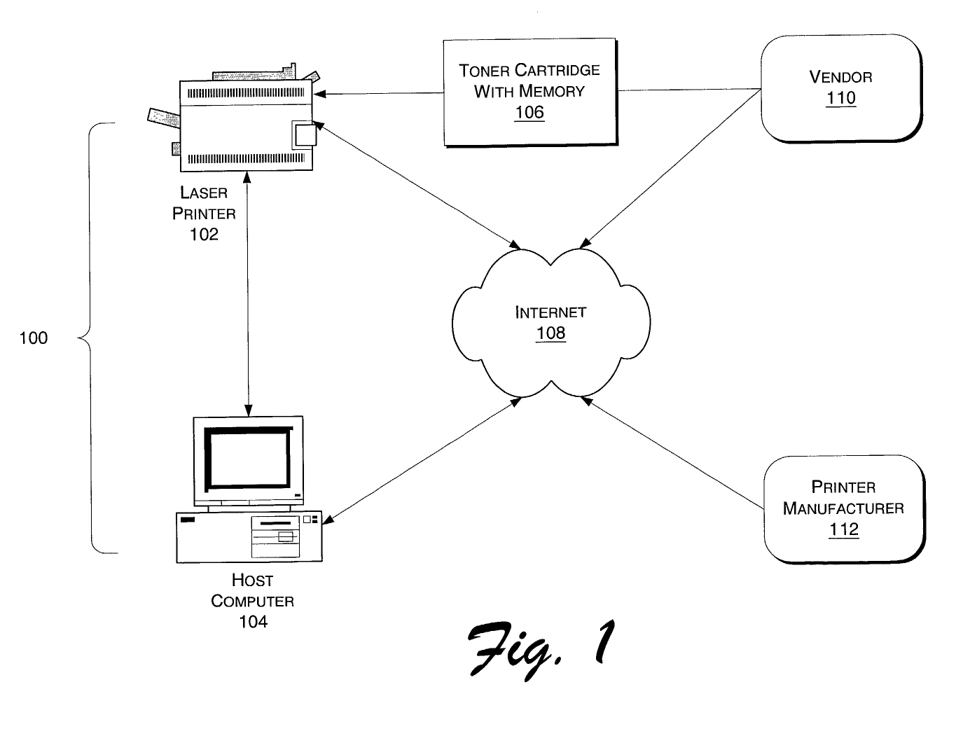

FIG. 1 depicts a printing system 100 that includes a printing device, laser printer 102, that is connected to a host computer 104. Although the host computer 104 is shown as comprising a stand-alone computer, it is noted that the host computer 104 may be but one computer in a computer network. In such a situation, the laser printer 102 could be connected to the computer network via the host computer 104 or by a direct network connection. In addition, the printing device, although shown as laser printer 102, may comprise any printing device that may be connected to the host computer 104 or to a computer network. Such a printing device may be a laser printer, an inkjet printer, a dry medium printer, a liquid electrophotography printer, a facsimile machine, a plotter, a copy machine, and the like.

The printing device contains a replaceable component that includes memory. In the present example, the laser printer 102 includes a toner cartridge 106 having memory. However, any replaceable component that has integrated memory may be utilized to accomplish the goals of the present invention. For example, instead of a toner cartridge with component memory integrated therewith, an ink cartridge or a photoelectric drum could be used as the replaceable component, as long as the replaceable component contains memory that can be configured to attain the objectives described herein.

The laser printer 102 and the host computer 104 communicate with the Internet 108, although any network with which the laser printer 102 and the host computer 104 may communicate to accomplish the objectives described herein may be utilized. A vendor 110 and a printer manufacturer 112 also communicate with the Internet 108.

The vendor 110 provides the toner cartridge 106 to be installed into the laser printer 102. The toner cartridge 106 includes memory (not shown) that stores information related to software updates for the printing system 100, i.e., the laser printer 102, the host computer 104, or both.

Software that can be updated in the laser printer 102 includes, but is not limited to, printer firmware or components thereof, java applets, color tables, reference tables, etc. Printer firmware includes processor-executable instructions that are generally core to operation of the printer. The firmware is typically stored in ROM (Read Only Memory), flash ROM or in non-volatile RAM (random access memory). Portions of the printer firmware may also be stored on a hard disk located within the printer. The firmware may include an embedded web server (EWS) that allows the printer to interpret Java applications (applets) that can either be permanently resident on the printer or dynamically downloaded to the printer. A color table is a reference table that described how to mix different color components to create a particular color.

Printing system software resident on the host computer 104 is a collection of applications that are installed on the host computer 104 to allow the host computer 104 to communicate with the laser printer 102 in a language compatible with the laser printer 102. This software also allows the host computer 104 to query the laser printer 102 for status. The system software is usually specific to a computer operating system such as Windows 95/98/2000/NT, Unix, Linux, OS/2, etc. The system software may be composed of several applications, such as a printer driver, a status utility, and administrative utility, etc. The printing system software on the host computer 104 includes, but is not limited to, all printer-related software (multiple applications), a single application, portions of an application (.exe or .dll files), etc.

As will be described in greater detail, below, the information stored in the toner cartridge 106 is used to notify a user of the availability of an update to printing system 100 software and allows printing system 100 software updates to be transferred from the vendor 110 or the printer manufacturer 112 to the laser printer 102 or the host computer 104 via the Internet 108. The laser printer 102 and the host computer 104 are both capable of receiving software update information over the Internet 108. Once the software update is downloaded to either the laser printer 102 or the host computer 104, it can be transferred to the other component(s) of the printing system 100.

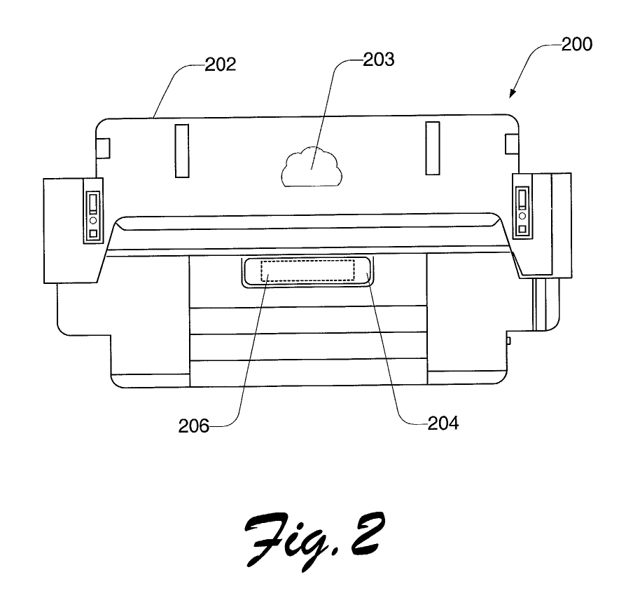

FIG. 2 is an illustration of a toner cartridge 200 that may be installed into the laser printer 102 shown in FIG. 1. The toner cartridge 200 includes a housing 202 and a toner reservoir 203 that is fillable with toner. The toner cartridge 200 also includes a label 204 that contains information identifying the toner cartridge 200 to a user. The label 204 typically recites the name of the manufacturer, the model number of the cartridge, etc.

A memory tag 206 is located underneath the label 204 on the toner cartridge 200, although the memory tag 206 may be placed on the toner cartridge 200 at any location that may be practical for the purposes described herein. The memory tag 200 is preferably a radio frequency identification (RFID) memory tag. RFID memory tags and applications therefor are well known in the art. Further aspects of the RFID memory tag 206 will become clearer as the discussion progresses.

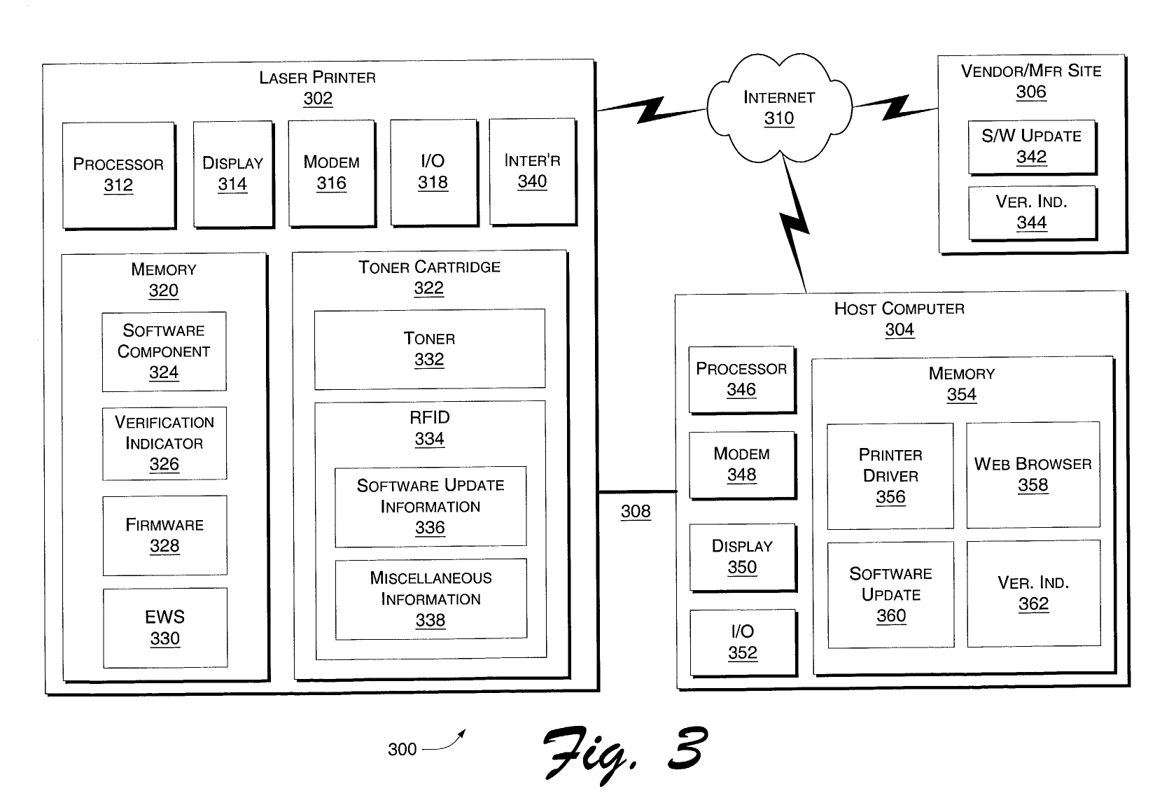

FIG. 3 is a block diagram of a system 300 for managing software updates for printing systems. As shown, the system 300 includes a laser printer 302, a host computer 304 and a vendor/manufacturer web site (V/M web site) 306. It is noted that the V/M web site 306 is a combination of a vendor web site and a manufacturer web site. Multiple vendors and/or manufacturers may maintain separate web sites. Further reference may be made to a vendor web site 306 or a manufacturer web site 306—both are meant to refer to V/M web site 306. The laser printer 302 is connected to the host computer 304 with a parallel port connection 308. The host computer 304 and the vendor site 306 communicate with the Internet 310.

The system 300 shown is a simplified system chosen as a matter of convenience for discussion. However, a more likely scenario is a system having dozens or hundreds of host computers and printing devices. The advantages of the methods described herein are realized to an even greater extent than described herein with regard to a simplified system shown in FIG. 3.

The laser printer 302 includes a processor 312, a display 314, a modem 316 for connecting directly to the Internet 310, and an I/O subsystem 318 that transmits and receives data via the parallel port connection 308 to the host computer 304. The laser printer 302 also includes memory 320 and a toner cartridge 322. The memory 320 includes at least one software component 324, a verification identifier 326, printer firmware 328 and an embedded web server (EWS) 330. The functions of these features will be described in greater detail, below.

The toner cartridge 322 includes a toner reservoir 332 and a memory tag 334. As previously stated, the memory tag 334 is preferably an RFID (radio frequency identification) memory tag 334, although it is noted that the memory tag 334 could be conventional semiconductor memory. If, however, the memory tag 334 is a semiconductor, then additional components may be required within the laser printer 302. Such additional components and their interaction with a semiconductor memory tag are well known in the art and, as such, will not be described at length herein.

The RFID memory tag 334 stores software update information 336 and can also include other miscellaneous information 338, such as a manufacturer name, a cartridge model number, a page counter, etc. The exact nature and composition of the software update information 336 will be described in greater detail, below.

The RFID memory tag 334 is designed to operate in conjunction with an interrogating device, also known as an interrogator. An interrogator is a device that provides power to the RFID memory tag 334 and reads from and/or writes to the RFID memory tag 334. Examples of interrogators include a memory tag reader or scanner, a memory tag writing device that stores data on the memory tag 334, and the like. In the present example, the laser printer 302 includes an interrogator 340.

The interrogator 340 emits a radio frequency field that provides power to the RFID memory tag 334 via an antenna coil (not shown). The RFID memory tag 334, therefore, does not require its own power supply, a feature that adds to the cost efficiency and practicality of utilizing the RFID memory tag 334.

Communications between the interrogator 340 and the RFID memory tag 334 are transmitted and received via the radio frequency field and the antenna coil (not shown) utilizing standard RFID methods and protocols, such as promulgated in ISO 14443 and ISO 15693. Therefore, physical contact between the RFID memory tag 334 and the laser printer 302 is not required for the laser printer 302 to communicate with the RFID memory tag 334.

Another advantage of the RFID memory tag 334 is that is can be written to at any time during the manufacturing/distribution phase. In some cases, it is advantageous to store data in the RFID memory tag 334 after the toner cartridge 322 is manufactured, after it has been determined to whom the toner cartridge 322 will be delivered. Furthermore, data can be stored in the RFID memory tag 334 through several layers of packaging, so it is feasible to simultaneously store information in the RFID memory tags of several toner cartridges.

For example, suppose a pallet of cartridges has been bundled for shipment to a non-English-speaking country. If the RFID memory tag of each toner cartridge contains information to be displayed to a user in such a country, then it is desirable to know the destination of the toner cartridges before writing to the RFID memory tags so that the information can be stored in an appropriate language. By using RFID memory, language-specific information can be simultaneously stored in each of the RFID memory tags in the entire pallet of packaged toner cartridges. This eliminates the need for making language substitutions in the cartridge manufacturing process and tracking the language-specific cartridges through shipment of the cartridges. As will be discussed in greater detail, below, this feature can be utilized for similar purposes in the described implementations.

In one implementation, the software update information 336 is the entire update or a pointer to the update. In this instance, a printing system user would have to manually determine whether an update to printing system 300 software is required. If so, the update is loaded into the printer memory 320 to replace the current software component 324. If the update is required to the host computer 304, then upon authorization by a user, the software update is passed from the laser printer 302 to the host computer 304.

In another implementation, the software update information 336 contains a version number of the latest software available for the printing system 300 or a pointer to such information. The printing system 300 compares the version number against a version number of the current software. If the version number included with the toner cartridge 322 indicates that a newer version of the software is available, a printing system user locates the update and installs it in the printing system upon authorization from the user.

The software update information 336 in another implementation contains a version number of the latest software available for the printing system 300 (or a pointer to such information) and a pointer to a location where the latest version update can be retrieved. The printing system 300 compares the version number from the toner cartridge 322 to the current software and if an update is required, access the location indicated by the pointer and downloads the update from that location. This is done either by notifying an appropriate authority (user, system administrator, etc.) for authorization to update the printing system 300 software, or the printing system 300 may be configured to accomplish this automatically.

In yet another implementation, the software update information 336 is a pointer to an Internet site. When the toner cartridge 322 is installed into the laser printer 302, the site referenced in the software update information 336 is accessed to determine if a later version of the printing system 300 software is available. If so, the update is downloaded from that location if authorized by a user.

The V/M web site 306 includes a software update 342 and a verification indicator 344. The software update 342 is a set of computer-executable instructions that is downloaded to the host computer 304 or the laser printer 302 via the host computer 304. The software update 342 also includes a version of the software. The verification indicator 344 is used to verify that a user has authorized downloading the software update 342 to the user's system.

The host computer 304 includes a processor 346, a modem 348, a display 350 and an I/O (input/output) unit 352 for communicating with the laser printer 302. The modem is configured to connect to the V/M site 306 via the Internet 310. Although a modem 348 is shown included in the host computer 304, it is noted that any device that can communicate with a remote site via a network may be used.

The host computer 304 also includes memory 354, which stores a printer driver 356, a web browser 358, a software update 360 and a verification indicator 362. The printer driver 356 is a software module that is stored when the laser printer 302 is installed and designates certain printer parameters to the host computer 304 to enable the host computer 304 to communicate with the laser printer 302. The web browser 358 is a software utility designed to browse a network. Specifically in this example, the web browser 358 is a software component that is used for browsing the Internet 310. The software update 360 is the same set of computer-executable instructions stored at the V/M site 306, after the software update 342 at the V/M site 306 is downloaded to the host computer 304, either directly or via the RFID memory tag 334 of the laser printer 302. The software update 360 may execute on the host computer 304 as part of the operation of the laser printer 302, or it may be downloaded to the laser printer 302 for execution on the processor 312 of the laser printer 302.

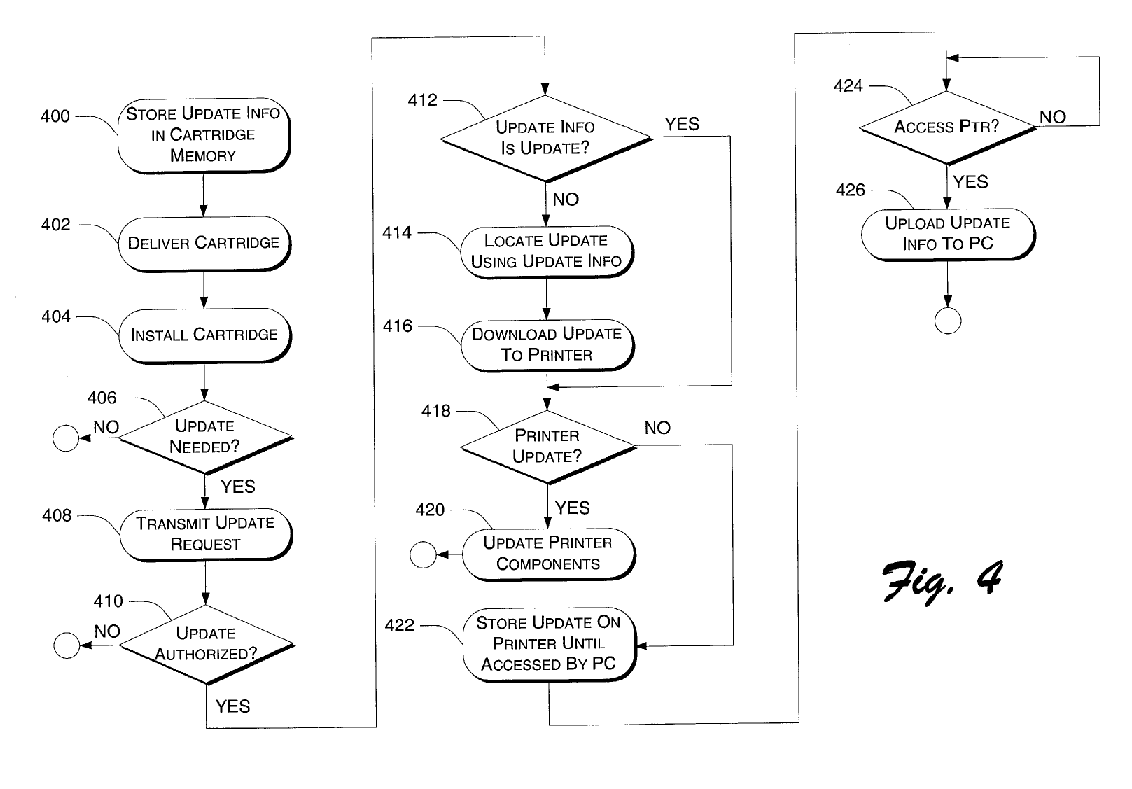

FIG. 4 is a flow diagram outlining a method for managing software updates for printing systems. The following discussion is made with continuing reference to FIG. 3.

At step 400, the software update information 336, 360 is stored in the RFID memory tag 334 of the toner cartridge 322. This can be done by a manufacturer of the toner cartridge 322 as part of the manufacturing process or it can be performed by a vendor. If it is done by the vendor, the vendor can store the entire software update information 336 in the RFID memory tag 334 with or without modifications, or the vendor may simply add vendor-related information to an existing software update already stored in the RFID memory tag 334. For example, it may be desirable for the software update information 336 to include vendor information or a reference thereto, such as a telephone number for ordering or a website address so that a printer user will know where the toner cartridge 322 was purchased and where a replacement can be ordered.

If the manufacturer of the toner cartridge 322 stores the software update information 336, then the manufacturer may have to customize batches of toner cartridges depending on the vendor who will receive and distribute the toner cartridges. Otherwise, the manufacturer may provide the vendor with a preliminary version of the software update information 336 and the vendor may then supplement this version with vendor information before storing the software update information 336 on the toner cartridge 322.

In a preferred embodiment, the memory tag 334 comprises RFID memory. In this case, a vendor receives a shipment of packaged toner cartridges from the manufacturer. If the final destination is a large enterprise that orders toner cartridges in bulk, the vendor can store the software update information 336 in the RFID memory tag 334 while the packaged toner cartridges are still on a shipping pallet. Otherwise, the software update information 336 is stored in individual toner cartridges while the toner cartridges remain packaged in the original container.

At step 402, the toner cartridge 322 is delivered to a user using any standard shipping method presently known. When the toner cartridge 322 is installed in the laser printer 302 at step 404, the laser printer 302 detects the installation and initiates an install program at step 406. Several sub-processes may also execute during the install program, such as providing a toner cartridge number or cartridge manufacturer name, etc., to the laser printer 302.

At step 406, it is determined if an update to printing system software is needed. The manner in which this is accomplished depends upon the contents of the software update information 336 in the memory tag 334 of the toner cartridge 322. For discussion purposes, assume that the software update information 336 comprises a revision number of the latest software update 342 available and a pointer to the location of the software update 342. Note, however, that several methods may be used to determine if an update is required, based on the contents of the software update information 336. Those skilled in the art will recognize, based upon the above discussion as to the contents of the software update information, what is required to accomplish this task.

The software component 324 versions of the laser printer 302 and the printer driver 356 of the host computer 304 are checked against the software update information 336 version to determine if a later version is available. If not, then the process is terminated (“No” branch, step 406). If a later version is available (“Yes” branch, step 406), then a message is transmitted for authorization to update the software at step 408. This authorization request may be handled in several ways.

The request to authorize an update may be displayed on the display 314 of the laser printer 302. The request may be displayed on the display 350 of the host computer 304. The message may also be transmitted to a network manager for authorization if the laser printer 302 is a part of a distributed network. Any manner in which an appropriate person can be asked to authorize an update may be utilized. If the request is denied, then the process is terminated (“No” branch, step 410). If the user responds to the prompt in the affirmative, then the software update information 336 is activated (“Yes” branch, step 410).

As an alternative to prompting a user before providing the update, there are ways in which a user may pre-authorize such updates. For example, the vendor may have previously asked the user whether the user would like any subsequent software updates for the laser printer 302 to be automatically loaded. If the user agrees to this, then the verification indicator 344 stored at the V/M site 306 is set, and the verification indicator 344 is associated with the user. If such an implementation is provided, then the install program automatically transmits an authorization request to the V/M site 306, either directly or via the host computer 304. If the verification indicator 344 associated with the user is set, then the authorization is confirmed and the update is automatically installed on the laser printer 302.

In another implementation, a user may pre-authorize subsequent software updates at the time the laser printer 302 is installed on the host computer 304. In this case, a verification indicator 362 is created and set in the memory 354 of the host computer 304. When requests are received from the laser printer 302 to download new software updates, the verification indicator 362 is checked and, if set, the software update 342 is downloaded to the host computer 304. The software update 360 is then stored in the memory 354 of the host computer 304. From there, the software component 324 in the memory 320 of the laser printer 302 may be updated.

The verification indicator 326 in the memory 320 of the laser printer 302 is handled similarly to the verification indicator 362 in the host computer 304. When the laser printer 302 is installed on the host computer 304, the user may pre-authorize future software updates. This may also be accomplished when the toner cartridge 322. If pre-authorization is done, then the verification indicator 326 is created and set for future reference. If the user does not opt to accept future updates, then the verification indicator 326 is created, but it is not set. It is also noted that the verification indicator 326 may be created at the time the contents of the memory 320 are installed. In this case, the verification indicator 326 would not be set until the user authorizes future software updates. At step 412, it is determined if the software update information 336 in the toner cartridge 322 is, itself, the entire update. If not (“No” branch, step 412), then the software update information 336 contains a pointer to the software update 342. The software update 342 is located at step 414 and downloaded to the laser printer 302 at step 416. In an alternative implementation, the software update information 336 is downloaded to the host computer 304.

The software update 342 is checked at step 418 to determine if it includes an update to the software component 324 of the memory 320 in the laser printer 302. If so (“Yes” branch, step 418), then the software component 324 is updated at step 420. It is noted that, as previously discussed, there are several items that may be updated in the laser printer 302. For convenience purposes, however, discussion is directed to updating only a generic software component 324.

If the software update 342 does not include an update for the laser printer 302 (“No” branch, step 418), then the software update is stored on the laser printer 302 until the laser printer 302 is accessed by the host computer 304 (step 422). When the laser printer 302 is accessed by the host computer 304 (“Yes” branch, step 424) the software update 342 is uploaded to the host computer 304 at step 426. As long as the host computer 304 does not access the laser printer 302 (“No” branch, step 424, the software update remains dormant.

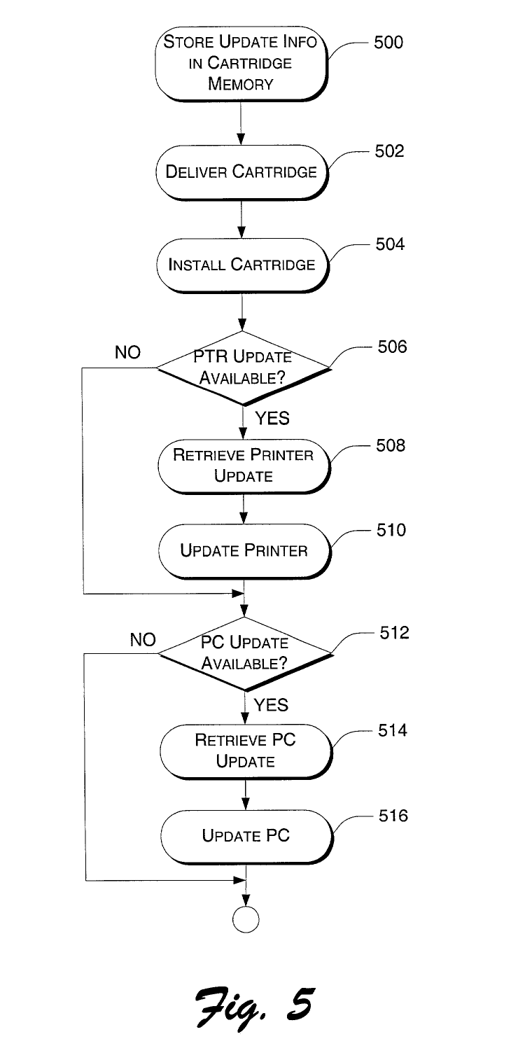

FIG. 5 is a flow diagram that outlines a method for automatically updating software components of a printing system. Continuing reference will be made to FIG. 3 in the discussion of FIG. 5.

At step 500, the software update information 336 is stored in the RFID memory 334 of the toner cartridge 322. The toner cartridge 322 is delivered to an end user at step 502 and is installed into the laser printer 302 at step 504. Steps 500-504 are identical to steps 400-404, discussed above.

At step 506, the software update information 336 is utilized to determine if an update to software for the laser printer 302 is available. If so (“Yes” branch, step 506), then the software update 342 related to the laser printer 302 is retrieved at step 508 and the software component 324 of the laser printer 302 is updated at step 510. Otherwise (“No” branch, step 506), the process continues at step 512, where a determination is made as to whether an update to software for the host computer 304 is available. If so (“Yes” branch, step 512), then the software update 342 related to the host computer 304 is retrieved at step 514 and the printer driver 356 (or some other software component) of the host computer 304 is updated (step 516). Otherwise (“No” branch, step 512), no update for the host computer 304 is retrieved.

The process outlined in FIG. 5 is similar to the process outlined in FIG. 4 and there are variations as to how the steps are accomplished. It is noted, however, that the steps outlined in FIG. 5 can be accomplished automatically, i.e., without human intervention. This may be desirable in many instances.

### Conclusion

The systems and methods described herein provide a convenient, efficient way for providing software updates to printing systems. The user is not required to do anything other than the user normally would do (install the toner cartridge) unless an implementation is utilized wherein each update must be manually authorized. In this manner, a printing device user will almost always have the latest software that is available and the vendor is provided with a low-cost, efficient method of distributing the update.

Although the implementation described herein have been described in language specific to structural features and/or methodological steps, it is to be understood that the invention defined in the appended claims is not necessarily limited to the specific features or steps described. Rather, the specific features and steps are disclosed as preferred implementations.

1. A method, comprising:
retrieving software update information from component memory of a printing device replaceable component;
validating authority to download a software update identified by the software update information; and
upon validation, facilitating a download of the software update utilizing the software update information from the component memory.

2. The method as recited in claim 1, wherein the validating further comprises producing a user prompt requesting authorization to download the software update and validating that authority has been granted to download the software update if the user responds in the affirmative to the user prompt.

3. The method as recited in claim 1, wherein the validating further comprises determining if a verification indicator is set in memory of the printing device and validating that authority has been granted to download the software update if the verification indicator is set.

4. The method as recited in claim 1, wherein the validating further comprises determining if a verification indicator is set in memory of a host computer connected to the printing device and validating that authority has been granted to download the software update if the verification indicator is set.

5. The method as recited in claim 1, wherein the validating further comprises accessing a remote site and determining if a verification indicator is set at the remote site and validating that authority has been granted to download the software update if the verification indicator is set.

6. The method as recited in claim 1, wherein the authority to download the software update is provided at the time the printing device is installed.

7. The method as recited in claim 1, wherein the facilitating further comprises downloading the software update from the component memory.

8. The method as recited in claim 1, wherein the facilitating further comprises accessing a pointer in the software update information and accessing a site referenced by the pointer to locate and download the software update.

9. The method as recited in claim 1, wherein the facilitating further comprises accessing a telephone number of a remote access site in the software information and utilizing the telephone number to locate and download the software update.

10. The method as recited in claim 1, wherein the facilitating further comprises accessing a telephone number of a vendor site in the software information and facilitating display of the telephone number to a printing device user, wherein the user can call the telephone number to order the software update.

11. The method as recited in claim 1, wherein the facilitating further comprises accessing a universal resource locator (URL) in the software information and facilitating display of the URL to a printing device user, wherein the user can manually access the URL to order the software update.

12. The method as recited in claim 1, wherein the facilitating further comprises accessing a printable form using the software information and causing the form to be printed on the printing device, wherein the user can complete the form and send it to a vendor to order the software update.

13. A printing device, comprising:
a replaceable component;
component memory integrated into the replaceable component; and
software update information stored in the component memory, the software update information including information to determine if there is an update available for the printing device and for initiating a software update upon authorization from a printing device user.

14. The printing device as recited in claim 13, wherein the software update information for initiating a software update further comprises means to display a message to the user that indicates how the user can obtain the software update.

15. The printing device as recited in claim 13, wherein the software update information for initiating a software update further comprises a pointer to an Internet site that may be provided to a browser of a host computer connected to the printing device so that the host computer can access the pointer and download the software update from the site.

16. The printing device as recited in claim 13, wherein the software update information for initiating a software update further comprises a pointer that may be provided to an embedded web server in the printing device so that the printing device can access the pointer and download the software update from the site.

17. The printing device as recited in claim 13, wherein the printing device is a laser printer and the replaceable component is a toner cartridge.

18. The printing device as recited in claim 13, wherein the printing device is an inkjet printer and the replaceable component is an ink cartridge.

19. A toner cartridge for a laser printer, comprising:
a housing;
a toner reservoir;
a memory tag; and
software update information stored in the memory tag that is retrieved by the laser printer and utilized to update software on the laser printer after obtaining authorization from a laser printer user.

20. The toner cartridge as recited in claim 19, wherein the software update information is utilized to update software in a host computer connected to the laser printer.

21. The toner cartridge as recited in claim 19, wherein the memory tag is a radio frequency identification (RFID) memory tag.

22. The toner cartridge as recited in claim 19, the software update information including a version number that indicates the latest version of software available for the laser printer and a pointer to a location that stores the latest version of the software available for the laser printer.
